(19) United States
(12) Patent Application Publication
(10) Pub. No.: US 2002/0069105 A1
(43) Pub. Date: Jun. 6, 2002

(54) Data processing system for targeted content

(76) Inventors: Alfredo Agnelo Judas Sebastiao do Rosario Botelho, Burlingame, CA (US); Roy Sunil de Souza, San Francisco, CA (US)

Correspondence Address: FLIESLER DUBB MEYER & LOVEJOY, LLP, FOUR EMBARCADERO CENTER, SUITE 400, SAN FRANCISCO, CA, 94111, US

(21) Appl. No.: 09/728,704

(22) Filed: Dec. 1, 2000

Related U.S. Application Data
(60) Provisional application No. 60/168,853, filed on Dec. 2, 1999.
(60) Provisional application No. 60/236,673, filed on Sep. 29, 2000.

(51) Int. Cl. G06F 17/60

(52) U.S. Cl. 705/14

(57) ABSTRACT

The present invention changes the traditional advertisement targeting process to a “pull” system of advertising, where users (e.g. consumers) decide what type of advertisements (or other content) they want to view. The user chooses one or more ad category preferences and the present invention serves one or more advertisements grouped within the chosen ad category preference(s) to a client device operated by the user. To serve the ad, the system builds a URL that includes a concatenation of information from a set of cookies. The URL is then used to locate the ad to be served. In one embodiment, the presence of a cookie with valid data is used as an indication that an advertisement according to the present invention should be served.

### CROSS-REFERENCE TO RELATED APPLICATIONS

This Application claims the benefit of U.S. Provisional Applications “Method and System for Providing Network Based Interactive Advertising,” Roy S. De Souza and Alfredo Botelho, Serial No. 60/168,853, filed on Dec. 2, 1999 and “Network Based Advertising,” Alfredo Botelho, Roy S. De Souza and Thomas Song, Serial No. 60/236,673, filed on Sep. 29, 2000. Both Provisional Applications are incorporated herein by reference.

### BACKGROUND OF THE INVENTION

1. Field of the Invention

The present invention is directed to an interactive system for providing targeted content. One example of targeted content includes advertisements; however, the invention can be used with other targeted content.

2. Description of the Related Art

The market for Internet advertising is enormous and is forecasted to be a $15-$20 billion market by the year 2004. However, web publishers currently have a large amount unsold ad inventory because much of the Internet space is difficult to utilize with traditional targeting technologies despite low “cost per thousand” (“CPM”) ad impression rates (an industry standard measure for selling ads on websites).

Some prior advertising campaigns “push” advertising through various technologies that utilize profiles that are stored in databases. Based on the information in the profiles, ad serving companies perform collaborative filtering or run complex algorithms in an attempt to target specific groups of consumers. Advertisers rely on this theory of behavioral targeting to predict consumers' future buying behavior based on past behavior. Other advertisers push advertisements based on user provided inputs (e.g. search terms to a search engine). Thus, in present forms of Internet advertising, advertisers must make educated guesses about the target audience and whether or not consumers from that target audience will find the ads relevant. The problem is that such guesswork is often wrong.

Thus, what is needed is a way for advertisers to remove this guesswork and provide consumers with advertisements that are relevant to their needs and interests.

### SUMMARY OF THE INVENTION

The present invention changes the targeting process to a “pull” system of advertising, where users (e.g. consumers) decide what type of advertisements (“ads”) they want. The user chooses a category and the present invention serves one or more advertisements grouped within the chosen category to a client device operated by the user. Typically, a category includes many advertisements that pertain to the subject matter of the category; however, it is possible that a category only includes one advertisement.

In one embodiment, when a user accesses a website on the Internet, the web page displayed will have one or more advertisements according to the present invention. Typically (but not required), the web page is a web page by a web publisher other than an entity associated with the servers of the present invention or the products of the advertisement. The advertisements will have an Ad Remote that includes a pull down (or tree) menu from which the user can choose an ad category preference (e.g. autos, sports equipments, financial products, etc.) from which one or more advertisements will be displayed to the user. In one embodiment, the user also chooses an ad subcategory preference (e.g., a “Sportscars” subcategory from the “Autos” category). In another embodiment, in addition to selecting the ad category and/or ad subcategory preference, the user can also select one or more additional attributes of the ad(s) to be displayed to the user. In yet another embodiment, instead of using a pull down menu, the user chooses an ad category preference and/or an ad subcategory preference by entering his or her choice(s) into an input text box. In one alternative, the selection of the category and the serving of the advertisement are performed in real time. That is, while a user is viewing a publisher's page, the user can select the category and receive the targeted advertisement.

Once an ad category preference is chosen, a default advertisement is then automatically replaced by one or more new advertisements selected from the consumer selected category of ads. Although an original advertisement is replaced with a new advertisement, the content of the web page is not changed. Subsequent accesses to the web page or any web page having an advertisement according to the present invention will display advertisements from the selected category. The advertisements are typically stored on a server, which can include a central advertisement database and/or a cache located at or remote from the dataabase.

In one embodiment, the web page includes a forwarding or advancing mechanism to allow the user to advance to a next advertisement grouped within the selected category of ads. In another embodiment, the web page includes a reversing mechanism to allow the user to return to a previous advertisement grouped within the selected category of ads. In yet another embodiment, the web includes a voting mechanism to permit the user to vote whether he or she likes or dislikes the advertisement.

As can be seen, the present invention serves targeted content in response to a user request for content pertaining to a particular category. This is in contrast to the prior art which serves advertisements based on algorithms that select an advertisement using a predetermined user profile.

The present invention can be implemented using software, hardware, or a combination of software and hardware. When all or portions of the present invention are implemented in software, that software can reside on a processor readable storage medium. Examples of an appropriate processor readable storage medium include a floppy disk, hard disk, CD-ROM, DVD, memory IC, etc. The hardware used to implement the present invention includes an output device (e.g. a monitor, network interface or printer), an input device (e.g. a network interface, keyboard, pointing device, etc.), a processor and processor readable storage medium in communication with the processor. The processor readable storage medium stores code capable of programming the processor to perform the steps to implement the present invention. In another embodiment, the present invention can be implemented using dedicated hardware without software.

These and other objects and advantages of the present invention will appear more clearly from the following detailed description in which the preferred embodiment of the invention has been set forth in conjunction with the drawings.

### BRIEF DESCRIPTION OF THE DRAWINGS

FIG. 1 is a block diagram of a computing system that can be used to implement the present invention.

FIG. 2 is a block diagram of a system overview of the present invention.

FIG. 3 is an overview of an ad retrieval process of the present invention.

FIG. 4 illustrates an exemplar web page having an interface enabling a user to choose a category of ads that the user wishes to view.

FIG. 5 is a flow chart describing the process for submitting an ad.

FIG. 5a is an exemplar binary bit pattern used to identify individual ads.

FIG. 6 is an exemplar interface that an advertiser can use to submit an ad.

FIG. 7 is a flow chart describing the process for purchasing ads.

FIG. 8 is a flow chart describing the process of generating an index file.

FIG. 9 is a flow chart describing the process of impression accounting.

FIG. 10 is a flow chart describing the operation of an AdRemote interface.

FIG. 11 is a flow chart describing a method for constructing a URL using the contents of one or more cookies.

FIG. 12 is a flowchart depicting a method for serving targeted content from a server to a client device based on an attribute in a cookie.

### DETAILED DESCRIPTION

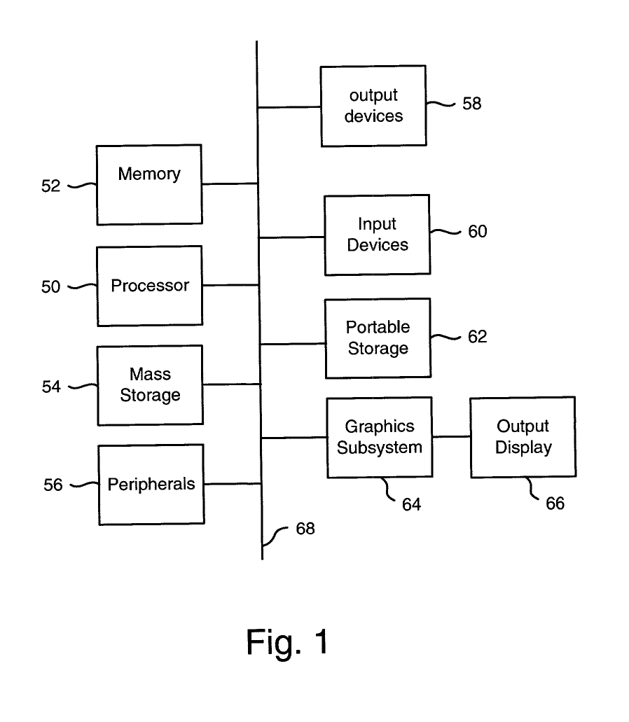

FIG. 1 illustrates a high level block diagram of a computer system which can be used for the present invention. The computer system of FIG. 1 includes a processor unit 50 and main memory 52. Processor unit 50 may contain a single microprocessor, or may contain a plurality of microprocessors for configuring the computer system as a multi-processor system. Main memory 50 stores, in part, instructions and data for execution by processor unit 50. If the system of the present invention is wholly or partially implemented in software, main memory 52 can store the executable code when in operation. Main memory 52 may include banks of dynamic random access memory (DRAM) as well as high speed cache memory.

The system of FIG. 1 further includes a mass storage device 54, peripheral device(s) 56, user input device(s) 60, portable storage medium drive(s) 62, a graphics subsystem 64 and an output display 66. For purposes of simplicity, the components shown in FIG. 1 are depicted as being connected via a single bus 68. However, the components may be connected through one or more data transport means. For example, processor unit 50 and main memory 52 may be connected via a local microprocessor bus, and the mass storage device 54, peripheral device(s) 56, portable storage medium drive(s) 62, and graphics subsystem 64 may be connected via one or more input/output (I/O) buses. Mass storage device 54, which may be implemented with a magnetic disk drive or an optical disk drive, is a non-volatile storage device for storing data and instructions for use by processor unit 50. In one embodiment, mass storage device 54 stores the system software for implementing the present invention for purposes of loading to main memory 52.

Portable storage medium drive 62 operates in conjunction with a portable non-volatile storage medium, such as a floppy disk, to input and output data and code to and from the computer system of FIG. 1. In one embodiment, the system software for implementing the present invention is stored on such a portable medium, and is input to the computer system via the portable storage medium drive 62. Peripheral device(s) 56 may include any type of computer support device, such as an input/output (I/O) interface, to add additional functionality to the computer system. For example, peripheral device(s) 56 may include a network interface for connecting the computer system to a network, a modem, a router, etc.

User input device(s) 60 provide a portion of a user interface. User input device(s) 60 may include an alpha-numeric keypad for inputting alpha-numeric and other information, or a pointing device, such as a mouse, a trackball, stylus, or cursor direction keys. In order to display textual and graphical information, the computer system of FIG. 1 includes graphics subsystem 64 and output display 66. Output display 66 may include a cathode ray tube (CRT) display, liquid crystal display (LCD) or other suitable display device. Graphics subsystem 64 receives textual and graphical information, and processes the information for output to display 66. Additionally, the system of FIG. 1 includes output devices 58. Examples of suitable output devices include speakers, printers, network interfaces, monitors, etc.

The components contained in the computer system of FIG. 1 are those typically found in computer systems suitable for use with the present invention, and are intended to represent a broad category of such computer components that are well known in the art. Thus, the computer system of FIG. 1 can be a personal computer, workstation, server, minicomputer, mainframe computer, Interactive TV, etc. The computer can also include different bus configurations, networked platforms, multi-processor platforms, etc. Various operating systems can be used including Unix, Linux, Windows, Macintosh OS, Palm OS, and other suitable operating systems.

The present invention provides a system and a method for serving targeted content, grouped according to a plurality of categories, to a client device. This self-targeted content may typically be advertisements but the present invention is not limited to only advertisements. For example, the present invention can be used to serve targeted messages of any kind grouped according to various categories to various client devices. As used herein, the client devices include, but are not limited to, an interactive television, an interactive radio, a computer, a mobile computing device, a personal digital assistant, a personal information manager, a telephone, a conventional cellular telephone, an Internet-enabled cellular telephone, etc. This document also makes references to the Internet as a delivery system, but the model applies to all two-way communication systems, including voice systems, data systems and other suitable systems.

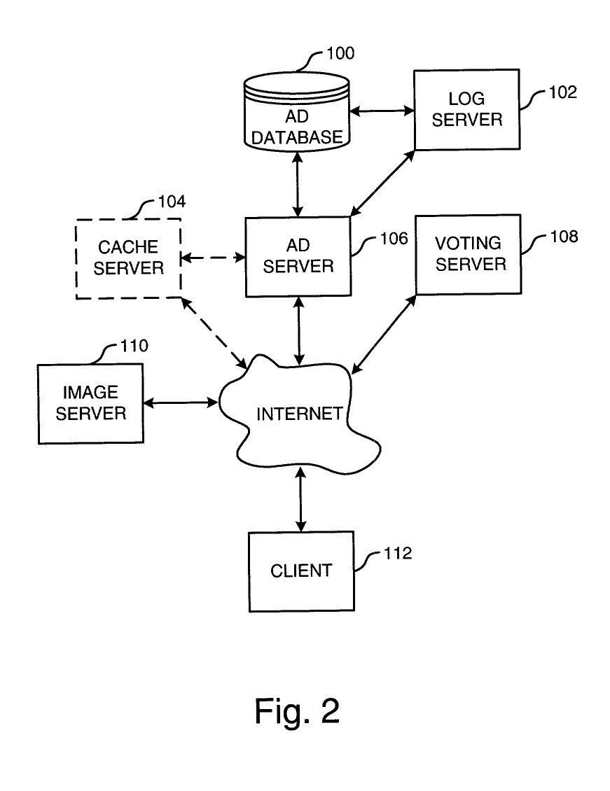

FIG. 2 illustrates an architectural overview of the present invention. FIG. 2 shows ad server 106 in communication with log server 102, cache server 104, ad database 100 and the Internet (or another network). Voting server 108, image server 110 and client 112 are also in communication with the Internet. In different embodiments, the various servers can communicate with each other directly, over a local area network, over the Internet or via other type of communication means.

A typical transaction envisioned by the present invention begins with a client 112 requesting self-targeted content object such as an advertisement (or othercontent). For example, client 112 is located in Japan and initially requests the advertisement from a local cache server. The local cache server could be one of thousands of similar cache servers distributed throughout the world by companies such as Akamai. The request for the advertisement typically contains three attributes needed to identify and locate the requested advertisement: a user selected category/subcategory of the ad, ad properties, and an ad index. The category/sub-category corresponds to a first attribute. The ad properties correspond to a second attribute. Finally, the ad index corresponds to a third attribute. As used herein, the first, second and third attributes are collectively referred to as the attributes.

Local cache server 104 tries to locate the requested advertisement using the first, second, and third attributes. However, if the requested advertisement does not reside on cache server 104, cache server 104 forwards the request to ad server 106 located at a central location. Typically, cache server 104 communicates with ad server 106 via the Internet. Ad server 106 locates the requested advertisement in an ordered list of ads and retrieves a logical location of the advertisement corresponding to the requested category/sub-category, ad properties, and ad index. The logical location of the requested ad object is derived by accessing an index file generated within the contents of ad database 100.

Ad database 100 stores information regarding categories of advertisements and respective subcategories, the number of impressions each advertiser has purchased for ad in a category and associated subcategory that has not been used, the names of each advertiser, and “AdID” to identify each advertisement stored in ad database 100. Ad server 106 then retrieves, for example, a GIF image file associated with the requested advertisement at the logical location corresponding to the first, second, and third attributes from image server 110, and ad server 106 serves this image to local cache server 104.

Local cache server 104 stores the retrieved advertisement in a physical location using a Uniform Resource Locator (“URL”) comprising the requested category/sub-category, ad properties and the ad index. In other words, the URL identifying the physical location of the retrieved advertisement is made up of the first, second, and third attributes. Ad server 106 also serves the requested advertisement to client 112. At the same time, ad server 106 accesses log server 102 and makes a record of what advertisement is being served. This information is recorded in log server 102 so that log server 102 can keep track of how many times respective advertisements have been served to client 112 (i.e., impressions). In addition to keeping track of how many impressions for respective ads have been served to client 112, log server 102 also provides a log summary to ad database 100 summarizing how many impressions have been served for each ad object. Thereafter, requests for the same ad object from other users in Japan, for example, are then served by local cache server 104. Users of client 112 can, at any time, vote on the merits of the retrieved advertisement. The user's vote as to whether he or she likes or dislikes the retrieved advertisement is stored in voting server 108 and a total vote tally for the retrieved advertisement is subsequently reported to the user at client 112.

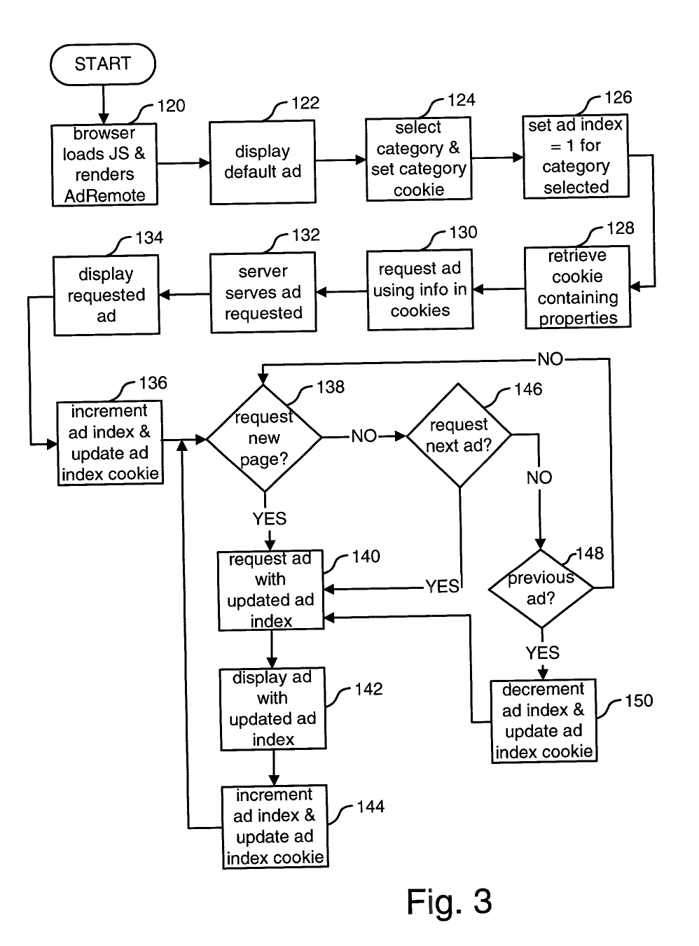

FIG. 3 is a flowchart describing an overview of the steps involved in retrieving an advertisement requested by client 112. Initially, in step 120, the ad retrieval process of the present invention begins by loading a web page that includes a Java Script program in accordance with the present invention. The Java Script can reside on the client or a server. The browser on client 112 loads the Java Script program and renders an “AdRemote” in accordance with the present invention. Once loaded, the Java Script program checks the environment of the client for the presence of any cookies to determine if transient or permanent properties have been specified for that client. Transient properties are those properties for a web page that can change in subsequent web pages (e.g., dimension of ad in one website may be different in a different website, ad may contain banners, buttons or squares. In contrast, permanent properties are those that do not vary as the user goes from one web page to another web page.

In accordance with the present invention, these properties can be specified in three ways. First, the user can specify the properties. The user can specify that no ads from a particular category be displayed regardless of which website he or she may visit. The user could thus, for example, request that no sexually suggestive ad ever be displayed regardless of which website he or she may be visiting. This would then result in a permanent property. Second, a publisher on whose website the requested ad is to appear may also specify the properties. For example, a website with content directed to families with young children could permanently specify that no sexually suggestive ads ever be displayed on its website regardless of whether the user wishes to see such ads or not. These properties are then transient since the user can simply visit another website whose publisher does not object to ads of a sexually suggestive nature. Third, the server such as ad server 106 can specify the properties. The server can, for example, determine the geographic origin of the user by the IP address of the incoming request and set the appropriate regional/language property. This would again be a transient property. In this way, a number of properties can be stored in one or more cookies on either the client side or the server side.

In one embodiment, the Java Script program then requests the AdRemote from the ad server having any one or a combination of these properties and the server responds by serving the AdRemote having these properties for that browser. For example, the AdRemote buttons can be rendered in Japanese if the client's IP address identifies it as a machine in Japan and subsequently only Japanese-language ads are displayed to the client. All this occurs within step 120. In step 122, a default advertisement is displayed until the user selects an ad category preference in step 124. In response to the user selecting an ad category preference, the category cookie as set depending on the ad category preference the user selected. An ad index for the selected ad category preference is then set in step 126 to be equal to one if the ad category preference has not been previously selected by the user. Like the first and second attributes (i.e., the ad category preference and the client properties) the ad index is also stored in a cookie. In accordance with the present invention, the cookie(s) containing the first, second and third attributes (i.e., the ad category preference, the properties, and the ad index) are then retrieved in step 128 and, in step 130, a request for an ad object identified by the three unique values of the first, second and third attributes is sent to the server. In step 132, the server identifies the advertisement corresponding to that particular combination of first, second and third attributes according to the process described above with respect to FIG. 2 and serves the requested advertisement to the client. In step 134, the requested advertisement is displayed on the client and, in step 136, the ad index is incremented by one and the updated ad index or third attribute is stored in a cookie.

In step 138 the present invention determines whether the user has requested a new web page. If the user has requested a new web page that uses the present invention, a request for a next advertisement within the user-selected ad category preference identified with the updated ad index is requested in step 140. In step 142, the advertisement with the updated ad index is received and displayed. In step 144, the ad index or third attribute is again incremented by one and the updated ad index is again stored in a cookie.

If, in step 138, the user does not request a new web page, the present invention determines whether the user has clicked on the “next” button of the AdRemote in step 146. If the user has clicked on the “next” button, a request for the next advertisement having the updated ad index is requested in step 140 and, in step 142 the next advertisement is displayed on the client. In step 144, the ad index is incremented and the updated ad index is stored in the cookie. In one embodiment, the system can include a timer that causes the next advertisement to be requested automatically after a predetermined time.

If, in response to step 146, the user has not chosen to view a next ad within the ad category preference selected, then in step 148, the present invention determines whether the user has clicked on the “previous” AdRemote button. If the user has chosen to view the previous advertisement then, in step 150, the ad index or third attribute is decremented by one and the updated ad index is stored in a cookie. After step 150, the method proceeds to step 140 and a request for an advertisement with the updated ad index is made to the server. The server responds with the requested advertisement and, in step 142, the previous advertisement is displayed. In step 144, the ad index is incremented by one and the updated ad index is stored in a cookie. If, in response to step 148, the user has not chosen to view a previous advertisement, then the present invention returns to step 138 to determine whether or not the user has requested a new web page.

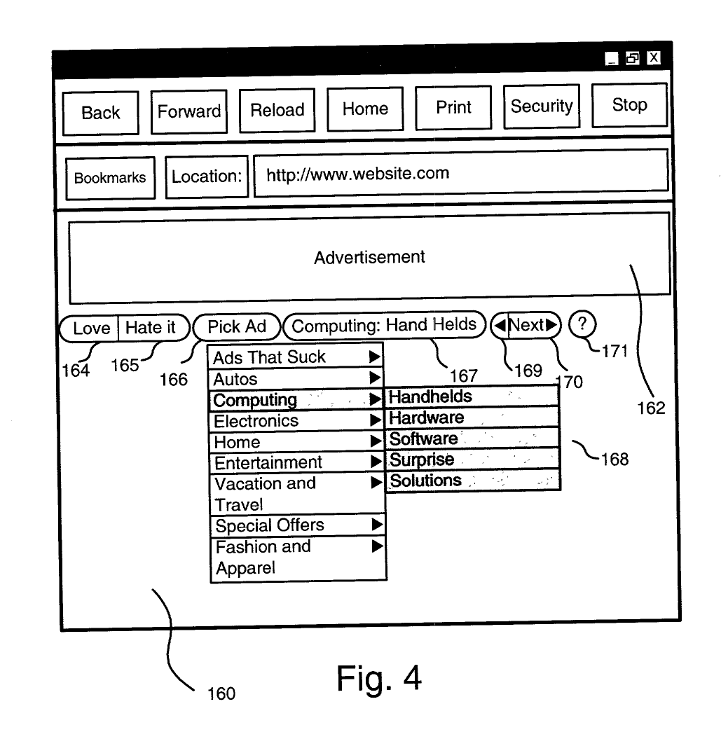

FIG. 4 illustrates a portion of a web page 160 loaded on a client device having an advertisement 162 served according to the present invention and an interface enabling a user to choose a category of ads that the user wishes to view. In this example, the web browser has already requested and loaded the java script program received from the server, and AdRemote buttons 164, 165, 166, 167, 169, 170 and 171 have been rendered. The user in this example has selected the “Computing” category and “Handhelds” subcategory 168 from the pull-down menu that appeared when the user clicked on AdRemote button 166. In one embodiment of the present invention, instead of clicking on AdRemote button 166 and selecting an ad category preference from a pull-down menu, the user could type the ad category preference into an input text box. The user could begin viewing ads retrieved from the selected ad category preference by simply pressing the return key.

In one alternative, AdRemote buttons are selected by clicking on a button with a pointing device (e.g. a mouse). In another alternative, AdRemote buttons can be selected by positioning the cursor over the button without clicking (e.g. the mouse-over feature). In another alternative, a combination of clicking and mouse-over can be used. For example, the mouse-over feature can be used to select a menu and clicking can be used to select a menu option.

FIG. 4 shows an AdRemote below a banner ad. In other embodiments, the AdRemote can be inside the banner ad, inside another type of ad or positioned at other locations.

The ad index (third attribute) for the Computing/Handhelds ad category preference is set to 1. When a new web page is loaded that uses the technology of the present invention, or if the next ad button 170 is selected, the ad index is then incremented by and the new ad index 2 is stored in a cookie. A cookie is a file that is used by web sites to record data about a user. Cookies can be stored either on a server device or on a client device.

Assume now that some time has elapsed and the ad index has been incremented to, for example, 10 (i.e., the tenth ad from the Computing/Handhelds ad category). If the user wishes to view the previous ad, he or she can simply click on AdRemote button 169. This causes the ad index to be decremented to 9, and an ad having these first, second and third attributes (i.e., category =Computing/Handhelds, property=ad suitable for the CNN web page, and ad index=9) is served to and displayed on the client device.

While viewing any of the ads from the selected ad category preference, the user can click on AdRemote buttons 164 or 165 to vote on the merits of each ad. In each case, the user's vote is communicated to and recorded on voting server 108 and a total vote tally is then displayed to the user. At any time, the user can also click on AdRemote button 171 to either obtain “Help” information.

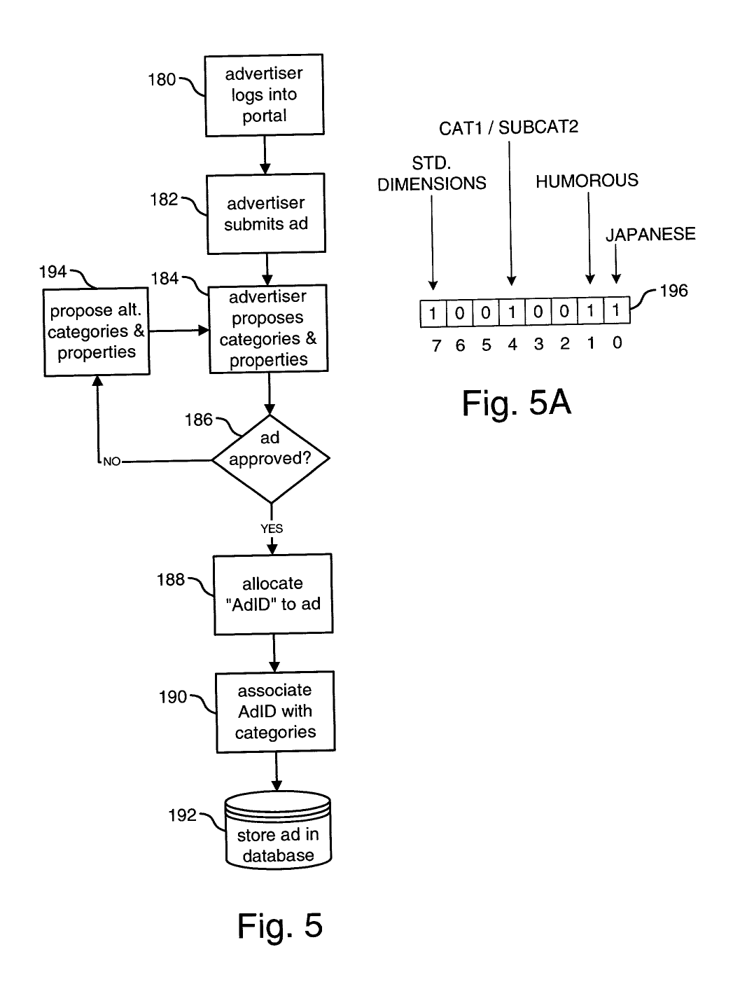

FIG. 5 is a flow chart describing the process by which an advertiser submits an ad in accordance with the present invention. The advertiser initially logs into a portal in step 180. In step 182, the advertiser submits an ad file. The advertisement may comprise a “.gif” file or several files for an HTML ad. In step 184, the advertiser classifies the advertisement using one or more predefined categories and subcategories, and properties. The properties may include language designations, geographic regions, type of content (e.g., adult, humorous, futuristic, etc.), and dimensions of the ad. For example, the advertiser may propose that the ad be classified as a futuristic, Japanese language ad, having a width 468 and a height of 60, in the “Computing” category and “Handhelds” subcategory. In one embodiment of the present invention, the advertiser can propose additional categories and subcategories not already available. In step 186, category managers determine whether the advertiser's proposal is acceptable. In one embodiment, the approval process is manual. In another embodiment, the approval process is automated. For example, if the advertiser proposes to classify a Japanese language ad for display on a Russian website, the ad proposal may be automatically rejected.

If the advertiser's proposed categories and properties are rejected, then, in step 194, the advertiser is prompted to propose an alternate category/subcategory and/or alternate properties. After step 194, the method loops to step 184. Using the previous example, the advertiser of the Japanese language ad could be prompted to specify the correct geographic property for the ad, namely Japanese language websites. If the ad is approved in step 186, then a unique “AdilD” is allocated to the ad in step 188. In step 190, the AdID is associated with one or more attributes 196 (e.g., category=Computing/Handhelds, properties=Japanese language ad, ad suitable for display on website selling computer equipment) to uniquely identify that ad. That is, to uniquely identify an ad, its AdID and its attributes 196 must be specified. Finally, in step 192, the ad and its attributes are stored in ad database 100.

FIG. 5a illustrates an exemplar binary bit pattern 196 used to identify attributes for individual ads. For every attribute chosen by a user, by an ad server, or by a publisher on whose website the ad will be displayed, the bit corresponding to the particular attribute is set to one. In this example, the first bit has been set to one to indicate a Japanese language ad. The second bit has been set to one to indicate a humorous ad. The fourth bit has been set to one to indicate an ad from the first category and the second subcategory. The eighth bit has been set to one to indicate an ad having standard dimensions. Thus, together with the AdID, this bit pattern identifies a unique, humorous, Japanese language ad from the first category and second subcategory having standard dimensions. While exemplar bit pattern 196 contains only eight bits, the present invention does not limit bit pattern 196 to eight bits. Depending on how many advertisements are stored and how many attributes have been specified, bit pattern 196 may comprise 8, 16, 32, 64, 128, or any other number of bits. In other embodiments, attributes can be identified by strings, characters, symbols or other means rather than a bit pattern.

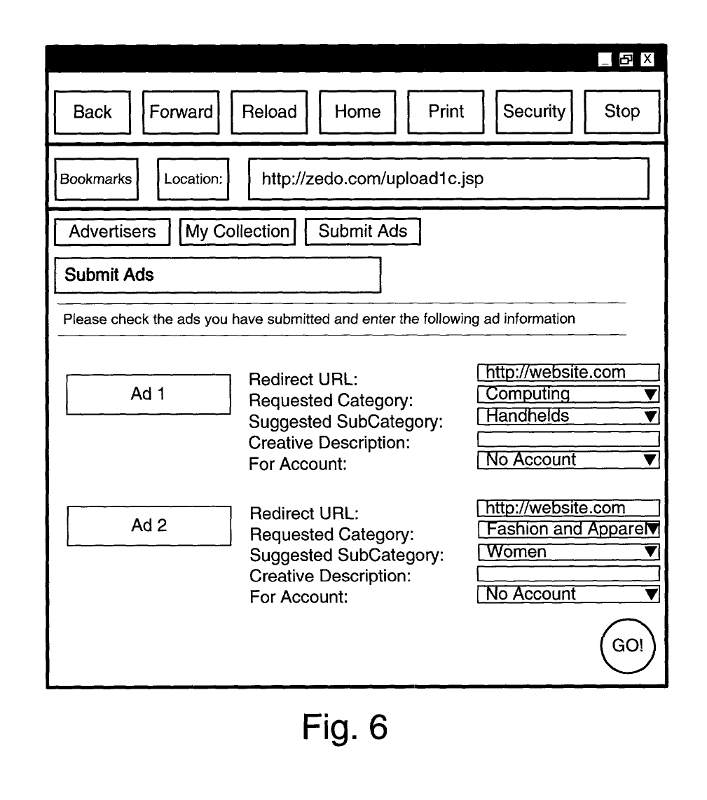

FIG. 6 shows an exemplar website 197 from a portal that an advertiser can use to submit an ad. Website 197 comprises, among other things, a “Redirect URL” text box 198, a “Requested Category” selection mechanism 200, a “Suggested Sub Category” selection mechanism 202, and a “Creative Description” text box 201. Text box 198 allows an advertiser to provide a URL that can be used to redirect a user to a website operated by the advertiser should the user choose to click on the advertisement displayed on client 112. The advertiser wishing to submit an advertisement uses selection mechanism 200 and 202 to classify the advertisement according to one or more predefined categories and subcategories. In one embodiment, the advertiser can propose that new categories and subcategories be added to available categories and subcategories in selection mechanisms 200 and 202, respectively. Text box 201 allows the advertiser to input a creative to further describe the advertisement. “Creative” is used to describe, for example, the style of the ad, the graphics used, and any music that may accompany the ad. Web site 197 is rendering of a web page.

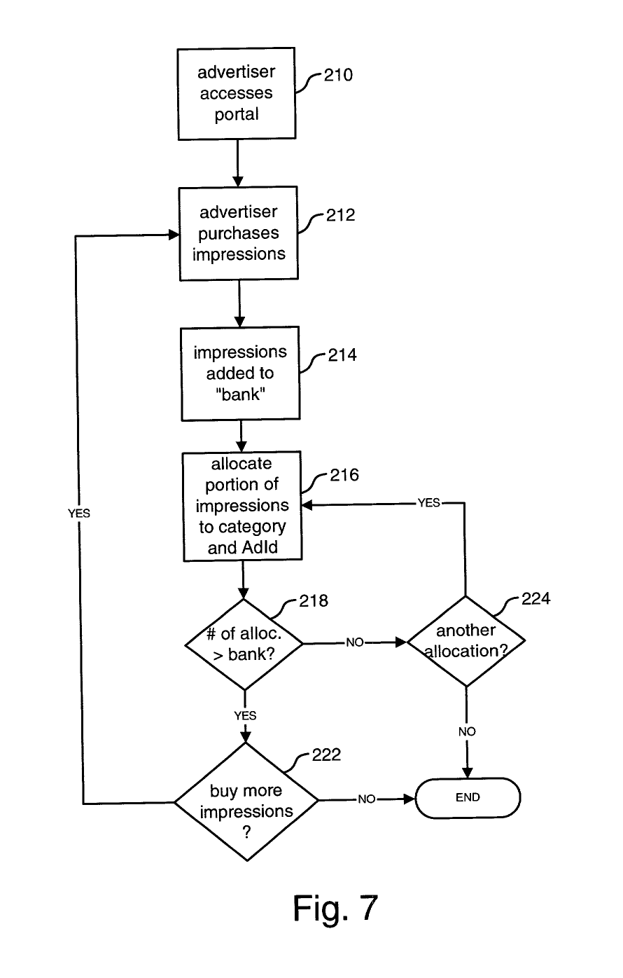

FIG. 7 is a flow chart describing the process by which an advertiser purchases impressions for advertisements, assuming that the advertisements have been approved for a particular category/subcategory. An impression is the count of a delivered basic advertising unit usually referred to as a view of the advertisement or a display of the advertisement on a rendering of a web page. Thus, an advertiser purchasing 10000 impressions is purchasing the right to have an advertisement displayed on one or more websites, for example, and viewed 10000 times. The advertiser initially logs into a portal in step 210. The portal may have access to a web page like that of FIG. 6. In step 212, the advertiser purchases impressions for an approved ad. In step 214, the impressions are added to a “bank” or an equivalent accounting system that tracks of how many ad impressions have been served. In step 216, the advertiser allocates the purchased impressions among one or more categories/subcategories, attributes, and specific advertisements.

In step 218, if the number of impressions allocated exceeds the number of impressions in the bank then the advertiser is asked to purchase more impressions in step 222. The advertiser is returned to step 212 if he or she wishes to purchase additional impressions. Otherwise, the process terminates.

If, in step 218, the number of impressions allocated does not exceed the number of impressions in the bank then the advertiser is asked whether he or she wishes to allocate additional impressions to another category/subcategory or advertisement in step 224. The advertiser is returned to step 216 if the advertiser wants to allocate impressions to another category or ad; otherwise, the process terminates if the advertiser does not wish to allocate additional impressions.

As an example, an advertiser who purchases 10000 impressions can allocate the purchased impressions among various categories and advertisements as long as the number of impressions allocated is less than or equal to 10000. If the advertiser inadvertently allocates more impressions than he or she has purchased, the advertiser is prompted to purchase additional impressions. In this way, the manufacturer of a computing device can purchase, for example, 10000 impressions and allocate 2000 impressions to Russian/Computing/Handhelds/AdId=X, 6000 impressions to USA/Computing/Handhelds/AdId=Y, and the remaining 2000 impressions to Japanese/Computing/Handhelds/AdId=X.

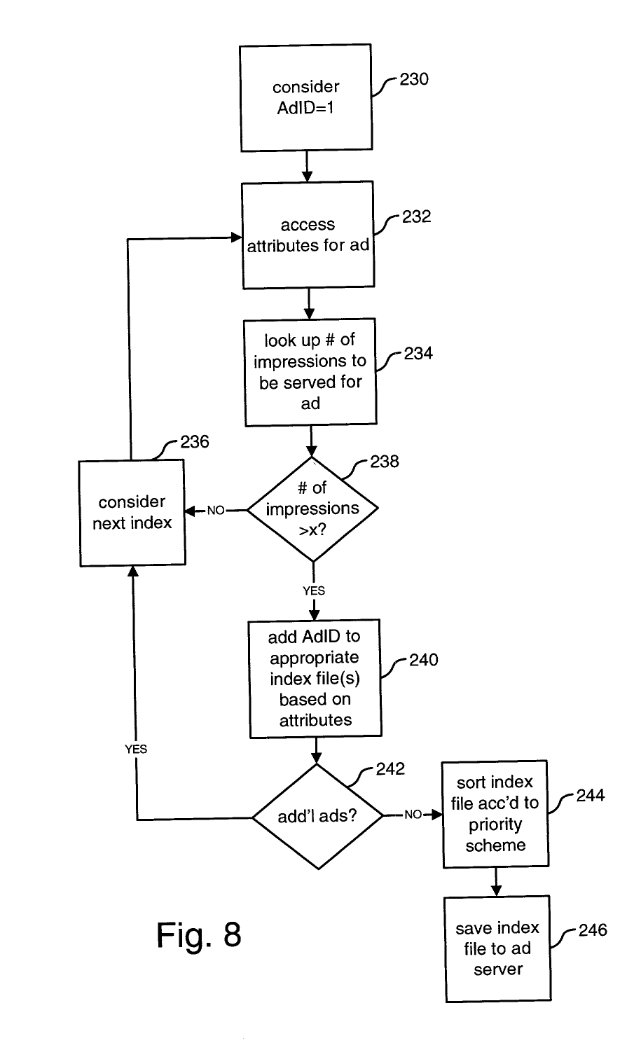

The universe of advertisements for the system of the present invention is divided into groups. Each group represents one permutation of the set of attributes. The system uses an index file for each permutation of the set of attributes (including category/subcategory) to keep track of which advertisements currently belong to the group and in what order should the advertisements be served. FIG. 8 is a flow chart describing the process for generating index files. In step 230, the system considers the advertisement with an ADId=1. In step 232, the system accesses the attributes for the advertisement under consideration. The number of impressions to be served for this ad under consideration is accessed in step 234. In step 238, the number of impressions to be served is compared to a predefined minimum threshold X (e.g. 5000 impressions). If the number of impressions to be served for the advertisement is greater than X, then in step 240, the advertisement under consideration is added to one or more appropriate index file(s) corresponding to the attribute set(s) designated for the advertisement. After step 240, the system determines whether there are more advertisements to consider in step 242. If so, the method loops to step 236 and the system considers the next advertisement. After step 236, the method loops to step 232.

If the number of impressions is not greater than X (step 23), the system considers the next advertisement (e.g. the ad having the next highest AdId) and loops to step 232. The index file or ordered list of ads is thus populated with ads, having respective AdIDs, which are to be served and viewed more than X times. This process continues until all advertisements are considered. After step 242 determines that there are no more advertisements to consider, the index file is sorted according to a priority scheme in step 244. The fully populated index file(s) are then saved to ad server 106 in step 246.

In one embodiment, the index files are sorted according to the number of impressions a given advertiser has purchased. In other words, the advertiser who has purchased the greatest number of impressions is given the highest priority in the index file and the advertiser who has purchased the least number of impressions is given the lowest priority in the index file. By highest priority, it is meant that the index file orders the advertisements so that advertisements with the highest priority are listed first in the index file and, therefore, are served first. The advertisements for a category/subcategory are served in the order listed in the index file. Accordingly, if advertiser A has purchased 100,000 impressions, advertiser B has purchased 80,000 impressions and advertiser C has purchased 50,000 impressions, advertiser A's ads would be placed at the top of the index file and be the first ads served. Advertiser B's ads would be “ranked” below that of advertiser A and advertiser C's ads would be ranked below that of advertisers B and C. This priority remains in place until, for example, 60,000 impressions of A's ads have been served, leaving only 40,000 impressions to be served (and B remains at 80,000 impressions and C remains at 50,000 impressions). At this point B's ads would be elevated in the index file and accorded the highest priority, C's ads would have second priority and A's ads would have third priority. This priority again remains in place until, for example, C's impressions sufficiently outnumber A's impressions and B's impressions. At that point, C's ads would be elevated in the index file and accorded the highest priority.

In another embodiment, the priority scheme is based on price. That is, the advertiser willing to pay the highest CPM would be accorded the highest priority in the index file.

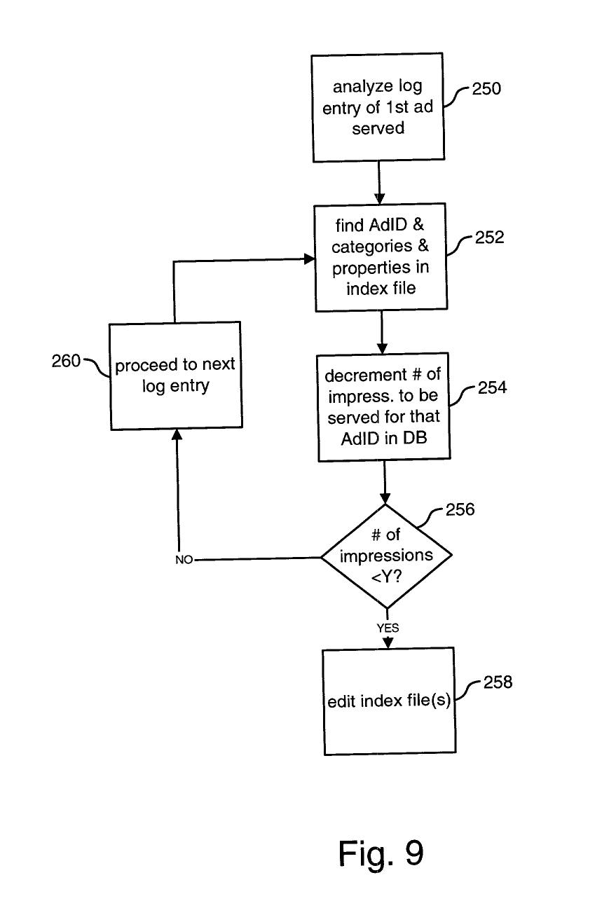

As ads are served, entries are sent to and stored in log server 102. The log entries are then used to monitor how many impressions each ad has received. FIG. 9 is a flow chart describing the process for keeping track how many ad impressions have been served. In step 250, a first log entry corresponding to the first ad served is analyzed. In step 252, the AdID and attributes (e.g., category, subcategory, geography, language, creative, etc.) associated with the first ad are retrieved. In step 254, the stored number impressions requested for the ad/attributes combo and not used is decremented. The number of impressions to be served for the advertisement under consideration is then compared against a predetermined threshold Y in step 256. One exemplar threshold is 1000. If the remaining number of impressions to be served for the advertisement under consideration is less than Y, then the index file(s) for the ad/attributes combo are edited to remove the advertisement from or change the order in the index file (step 258). However, if the remaining number of impressions to be served for the advertisement under consideration is greater than Y, then the system considers the next log entry in step 260 and loops back to step 252. This process continues until all log entries for all ads have been analyzed and impressions associated with each ad are compared against one or more predefined thresholds.

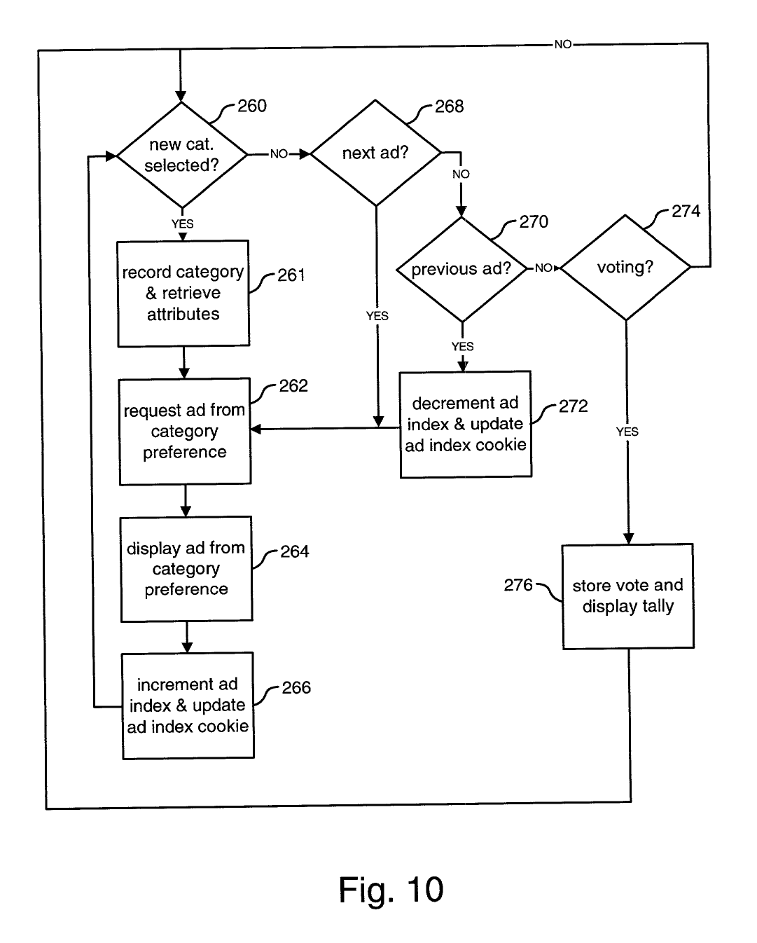

FIG. 10 illustrates the operation of an AdRemote in accordance with the present invention. Step 260 begins when a user has clicked on an AdRemote button. If the user has selected an ad category preference, then in step 261 the ad category preference is stored in a cookie and one or more attributes are retrieved from server-based cookies or client-based cookies. In step 262, the AdRemote requests an advertisement from one or more ads grouped in a server according to the advertisement category preference.

Each request contains at least a first attribute indicative of a user selected ad category preference, a second attribute indicate of one or more properties of either the requested ad or the client device (e.g., geography, language, adult content, etc.), and a third attribute indicating an ad index. The server identifies and retrieves a unique advertisement having the first, second and third attributes and this advertisement is served to and displayed on the client device in step 264. In one embodiment, the unique advertisement is located using the ad index as an index to the index file corresponding to the chosen category/subcategory. In step 266, the ad index (i.e., third attribute) is incremented by 1 and the updated ad index is stored in a cookie. After step 266, the process of waiting for a user's selection of another ad category preference then begins again in step 260.

In one embodiment, other advertisements from the same ad category (and/or subcategory) are automatically served to and displayed on the client device after some predefined amount of time has elapsed. This may occur even though the user may not have explicitly requested a “next” ad from the same ad category. In another embodiment, other ads from the same ad category are served to and displayed on the client device only if the user clicks on a “Next” AdRemote button.

However, if in step 260 the user does not select a new ad category preference, step 268 determines if the user wants to view a “Next” ad from among the numerous ads grouped according to the selected ad category preference. If the user wants to view the next ad (by clicking on a “Next” AdRemote button), the AdRemote requests the next ad in step 262 by using the previously incremented ad index. Once the next advertisement has been displayed on the client in step 264, the ad index is again incremented in step 266.

If, in step 268 the user does not select a button to view the next ad, then step 270 determines whether the user selected to view a “Previous” ad. If the user selected to view the previous ad (by clicking on a “Previous” AdRemote button), the AdRemote first decrements the ad index (and updates the ad index cookie) and then requests the previous advertisement in step 262 by using the new decremented ad index. Once the previous ad has been displayed on the client in step 264, the ad index is again incremented in step 266.

If, in response to step 270, the user also does not want to view a previous ad, then step 274 determines whether the user wants to vote on the ad that he or she has just seen. The user can click on either a “Love it” AdRemote button or a “Hate it” AdRemote button. The user's vote is communicated to and stored in voting server 108 and a total tally of votes is then displayed to the user. If the user also does not want to vote, the user is returned to step 260.

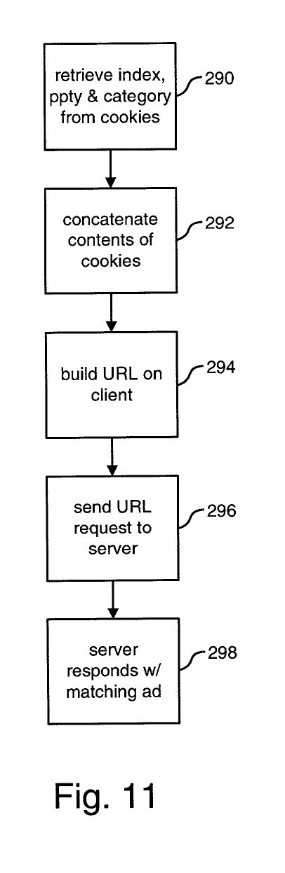

FIG. 11 is a flow chart describing a method for serving advertisements from a server to a client device based on one or more attributes of respective advertisement stored in one or more cookies. One or more attributes of an ad are communicated to the server in one or more cookies in step 290. The cookie(s) are likely to reside on the client requesting the ads; however, the cookies can be stored on the server or other locations in alternative embodiments. In one embodiment, all attributes are stored in one cookie. In another embodiment, each attribute is stored in an individual cookie. In step 292, the retrieved attributes are concatenated. In step 294, a Uniform Resource Locator (URL) using the concatenated attributes is constructed on the client device. The URL comprising the concatenated attributes is then sent to the server in step 296. Then, in step 298, the server uses the attributes in the URL to identify a matching advertisement which is then served to the requesting client device.

For example, a client device may have a first cookie containing a value for a particular category/subcategory (e.g., 100) that is represented by a first binary bit pattern. Each category and subcategory combination can be numbered. The client device may also have a second cookie containing a value for one or more properties (e.g., 17) that can be represented by a second binary bit pattern. The client device may yet have a third cookie containing a value for a specific ad index (e.g., 4) that can be represented by a third binary bit pattern. Instead of passing these respective binary bit patterns to the server in a request, and relying on server-side processing logic to map the contents of the individual cookies to a specific advertisement or targeted content, the present invention makes use of the resources of the client to perform the same function. In accordance with the present invention, the attributes retrieved from the cookies are concatenated together to form the following exemplar URL:

http://server/100/17/4.html.

This URL maps directly to the fourth ad within category/subcategory=100 having properties=17 on the host having a domain name of “server.” The server uses the URL to access the correct ad. In one embodiment, the server stores ads in a directory structure and the information in the URL points to the directory storing the ad and includes an index into that directory. In one alternative, the information in the URL explicitly states the directory where the advertisement is stored. For example, for the above URL, there would be a director named “100,” a sub-directory named “17” and a file within directory “17” with a filename of “4.” The file with a filename of “4” could store the advertisement or store a pointer to the advertisement. This scheme puts the logic in the URL so that the server does not perform decoding and the advertisements can be stored in a simple cache.

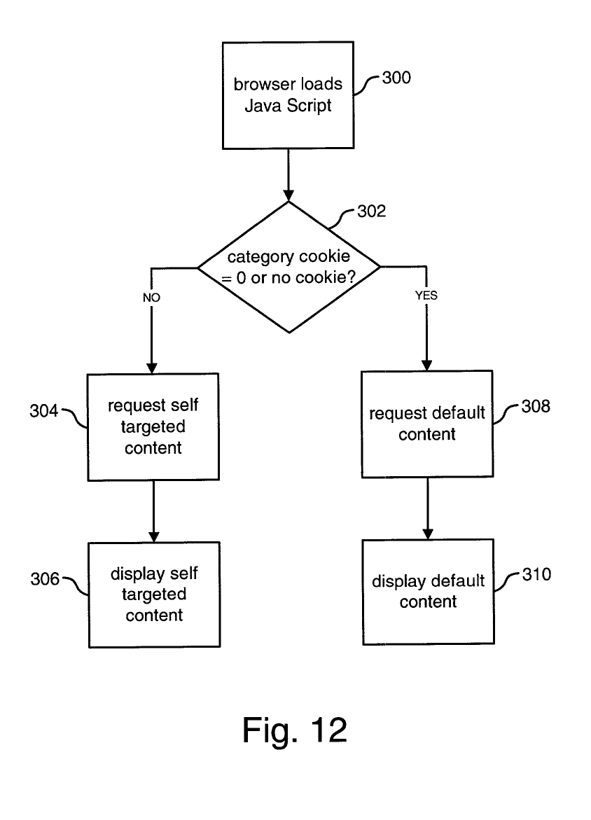

FIG. 12 describes a flowchart for one exemplar method for determining whether targeted content should be served. In step 300, the browser on the client device initially loads a Java Script program that renders the AdRemote discussed above. In step 302, the Java Script program checks to see whether a user has selected a category/subcategory preference by retrieving a category cookie on the client device. A non-zero category/subcategory attribute in a category cookie means that the user has selected a category/subcategory preference and the appropriate targeted content or targeted ads from within the selected category/subcategory are then requested by the client device in step 304 and displayed in step 306. However, if the category/subcategory attribute in the category cookie is zero or if there is no category cookie, then non-targeted content or default ads are requested by the client device in step 308 and displayed in step 310. Accordingly, advertisers with targeted content or targeted ads can be charged a higher CPM rate since their ads are reaching a targeted audience. An example of non-targeted content includes a traditional ad not according to the present invention.

The processes of FIGS. 11 and 12 can be used for environments other than advertisements. For example, the methods can be used for providing other targeted content, other types of information or access to various resources.

In an alternative embodiment, the user can be presented with an interface to choose an ad category prior to displaying a web page. This may be useful in environments that have small displays such as Internet-enabled telephones (e.g. WAP) or handheld computing devices. In one alternative, a user will have denied access to the content of a web page until a user selects an ad category.

The foregoing detailed description of the invention has been presented for purposes of illustration and description. It is not intended to be exhaustive or to limit the invention to the precise form disclosed, and obviously many modifications and variations are possible in light of the above teaching. The described embodiments were chosen in order to best explain the principles of the invention and its practical application to thereby enable others skilled in the art to best utilize the invention in various embodiments and with various modifications as are suited to the particular use contemplated. It is intended that the scope of the invention be defined by the claims appended hereto. CLAIMS

We claim:

1. A method of providing targeted advertising, comprising the steps of:
receiving information indicating a user selected category request for targeted advertising;
identifying a first advertisement corresponding to said category request; and
providing said first advertisement.

2. A method according to claim 1, wherein:
said step of receiving includes receiving a URL, said URL includes a first attribute and a second attribute concatenated in said URL; and
said step of identifying includes using at least a portion of said URL to find said first advertisement.

3. A method according to claim 1, wherein:
said category request includes a request for a category and a subcategory.

4. A method according to claim 1, wherein:
said first advertisement is a banner ad for a web page.

5. A method according to claim 4, further comprising:
displaying said advertisement on a client device.

6. A method according to claim 4, wherein:
said first attribute is received at a server from a client device; and
said step of providing includes communicating said advertisement from said server to said client device.

7. A method according to claim 1, further comprising the steps of:
receiving a second attribute indicating a property of a client device, said step of receiving information includes receiving a first attribute, said first attribute indicates said user selected category request; and
retrieving a third attribute indicating an index, said step of identifying is based on said second attribute and said third attribute.

8. A method according to claim 7, wherein:
said second attribute is selected by a publisher capable of controlling environmental characteristics of said client device;
said first attribute, said second attribute and said third attribute are received from said client device; and
said step of providing includes communicating said first advertisement to said client device.

9. A method according to claim 7, wherein:
said second attribute is selected by a server;
said first advertisement is stored at said server; and
said step of providing includes communicating said first advertisement from said server.

10. A method according to claim 7, wherein:
said second attribute is transient.

11. A method according to claim 7, wherein:
said second attribute is permanent.

12. A method according to claim 7, wherein:
said first, second and third attributes are represented by bit patterns.

13. A method according to claim 7, wherein said first, second and third attributes are stored in one or more cookies.

14. A method according to claim 13, wherein:
said one or more cookies reside on a server remote from said client; and
said step of providing includes communicating said first advertisement from said server to said client for display on said client.

15. A method according to claim 13, wherein:
said one or more cookies reside on a client device; and
said step of providing includes communicating said first advertisement from a server to said client for display on said client.

16. A method according to claim 1, further comprising the steps of:
receiving a request for a next advertisement corresponding to said user selected category request;
identifying said next advertisement; and
providing said next advertisement.

17. A method according to claim 1, further comprising the steps of:
receiving a request for a previous advertisement corresponding to said user selected category request;
identifying said previous advertisement; and
providing said previous advertisement.

18. A method according to claim 1, wherein:
said step of providing includes communicating said first advertisement to a client device; and
said client device includes an interactive television.

19. A method according to claim 1, wherein:
said step of providing includes communicating said first advertisement to a client device; and
said client device includes a mobile computing device.

20. A method according to claim 1, wherein:
said step of providing includes communicating said first advertisement to a client device; and
said client device includes a personal information manager.

21. A method according to claim 1, wherein:
said step of providing includes communicating said first advertisement to a client device; and
said client device includes a computer displaying a web site.

22. A method according to claim 1, wherein:
said step of providing includes communicating said first advertisement to a client device; and
said client device includes a cellular telephone.

23. A method according to claim 1, further comprising the steps of:
displaying a content selection interface at a client, said content selection interface includes a category selection device;
receiving said user selected category request based on said category selection device; and
communicating said user selected category request from said client to a server, said server performs said step of receiving a first attribute.

24. A method according to claim 23, wherein:
said category selection device includes a pull down menu displaying a set of categories.

25. A method according to claim 23, wherein:
said category selection device includes a text box.

26. A method according to claim 23, wherein:
said first advertisement is a banner and for a web page.

27. A method according to claim 26, further including the steps of:
displaying a first content page, said step of displaying a content selection interface is part of said step of displaying a first content page;
displaying a second content page;
sending a request from said client to said server for a second advertisement based on said user selected category; and
receiving and displaying said second advertisement on said client, said second advertisement is displayed with said second content page.

28. A method according to claim 26, further comprising the steps of:
receiving a vote about said advertisement;
adding said vote to a tally of votes; and
providing information about said tally of votes.

29. A method according to claim 1, wherein:
said steps of receiving, identifying and providing are performed in real time; and
said steps of identifying and providing are performed in response to said step of receiving.

30. A method according to claim 1, wherein:
said step of identifying is performed without making use of user profile information.

31. A method according to claim 1, wherein:
said step of providing includes only providing advertisements that correspond to said user selected category request.

32. One or more processor readable storage devices having processor readable code embodied on said processor readable storage devices, said processor readable code for programming one or more processors to perform a method, comprising the steps of:
receiving information indicative of a user selected category request;
identifying a first advertisement corresponding to said category request; and
providing said first advertisement.

33. One or more processor readable storage devices according to claim 32, wherein:
said first advertisement is a banner ad on a web page.

34. One or more processor readable storage devices according to claim 33, wherein:
said step of receiving information includes receiving a URL, said URL includes a first attribute and a second attribute concatenated in said URL, said first attribute identifies said user selected category request; and
said step of identifying includes using at least a portion of said URL as an explicit identification of a location within a file system to find said first advertisement.

35. One or more processor readable storage devices according to claim 33, wherein said method further comprises the steps of:
receiving a second attribute indicating a property of a client device, said step of receiving information includes receiving a first attribute, said first attribute indicates said user selected category request; and
retrieving a third attribute indicating an index, said step of identifying is based on said second attribute and said third attribute.

36. One or more processor readable storage devices according to claim 33, wherein said method further comprises the steps of:
receiving a request for a next advertisement corresponding to said user selected category request;
identifying said next advertisement; and
providing said next advertisement.

37. An apparatus, comprising:
one or more processors;
a communication interface in communication with said one or more processors and a network; and
one or more storage devices in communication with said one or more processors, said one or more storage devices store content, said one or more processors programmed to preform a method comprising the steps of:
receiving information indicative of a user selected category request,
identifying a first advertisement corresponding to said category request, and
providing said first advertisement.

38. An apparatus according to claim 37, wherein:
said first advertisement is a banner ad for a web page.

39. An apparatus according to claim 37, wherein:
said step of receiving includes receiving a URL, said URL includes a first attribute and a second attribute concatenated in said URL, said first attribute identified said user selected category request; and
said step of identifying includes using at least a portion of said URL as an explicit identification of a location within a file system to find said first targeted advertisement.

40. An apparatus according to claim 37, wherein said method further comprises the steps of:
receiving a second attribute indicating a property of a client device, said step of receiving information includes receiving a first attribute, said first attribute indicates said user selected category request; and
retrieving a third attribute indicating an index, said step of identifying is based on said second attribute and said third attribute.

41. An apparatus according to claim 40, wherein said method further comprises the steps of:
receiving a request for a next advertisement corresponding to said user selected category request;
identifying said next advertisement; and
providing said next targeted advertisement.

42. A method of providing targeted content grouped by categories, comprising the steps of:
displaying a user interface;
receiving a selection of a category using said user interface; and
displaying a first advertisement corresponding to said category.

43. A method according to claim 42, wherein:
said steps of displaying a user interface, receiving and displaying a first advertisement are performed in real time.

44. A method according to claim 42, wherein:
said user interface is displayed in a publisher page; and
said first advertisement is displayed in said publisher page.

45. A method according to claim 42, further comprising the steps of:
requesting said first advertisement based on said category; and
receiving said first advertisement from a server.

46. A method according to claim 45, wherein:
said step of requesting includes sending a set of attributes concatenated in a URL, said attributes identify said first advertisement.

47. A method according to claim 45, wherein:
said step of requesting includes sending a first attribute, a second attribute and a third attribute;
said first attribute pertains to said category;
said second attribute pertains to one or more properties;
said third attribute pertains to an index for said category; and
said first attribute, said second attribute and said third attribute identify said first advertisement.

48. A method according to claim 42, wherein:
said user interface includes a category selection device; and
said step of receiving a selection uses said category selection device.

49. A method according to claim 48, wherein:
said category selection device includes a text box.

50. A method according to claim 48, wherein:
said category selection device includes a pull down menu.

51. A method according to claim 48, wherein:
said first advertisement is an ad for a web site.

52. A method according to claim 51, further including the steps of:
displaying a first content page, said step of displaying said user interface is part of said step of displaying a first content page;
displaying a second content page;
sending a request for a second advertisement corresponding to said category;
receiving said second advertisement; and
displaying said second advertisement with said second content page.

53. A method according to claim 52, wherein said step of displaying a first content page includes the steps of:
displaying content;
determining whether valid selection information exists;
displaying a targeted advertisement if valid selection information exists; and
displaying a non-targeted advertisement if valid selection information is not found.

54. A method according to claim 53, wherein:
said step of determining includes looking for a valid cookie.

55. A method according to claim 54, further comprising the steps of:
receiving a vote about said first advertisement;
adding said vote to a tally of votes; and
displaying information about said tally of votes.

56. An apparatus, comprising:
one or more processors;
a communication interface in communication with said one or more processors and a network; and
one or more storage devices in communication with said one or more processors, said one or more storage devices store content, said one or more processors programmed to preform a method comprising the steps of:
displaying a user interface,
receiving a selection of a category using said user interface, and
displaying a first advertisement for said category.

57. An apparatus according to claim 56, wherein:
said first advertisement is a banner ad for a web page.

58. An apparatus according to claim 57, wherein said method further comprises the steps of:
requesting said first advertisement based on said category; and
receiving said first advertisement from a server.

59. An apparatus according to claim 57, wherein:
said step of requesting includes sending a set of attributes concatenated in a URL, said attributes identify said first advertisement.

60. An apparatus according to claim 57, wherein:
said step of requesting includes sending a first attribute, a second attribute and a third attribute;
said first attribute pertains to said category;
said second attribute pertains to one or more properties; and
said third attribute pertains to an index for said category.

61. An apparatus according to claim 57, wherein:
said user interface includes a category selection device; and
said step of receiving a selection uses said category selection device.

62. An apparatus according to claim 56, wherein said method further comprises the steps of:
displaying a first publisher's page, said step of displaying said user interface is part of said step of displaying a first publisher's page, said step of displaying a first advertisement includes displaying said first advertisement on said first publisher's page;
displaying a second publisher's page;
sending a request for a second advertisement based on said category;
receiving said second advertisement; and
displaying said second advertisement on said second publisher's page.

63. An apparatus according to claim 62, wherein said step of displaying a first publisher's page includes the steps of:
displaying content;
determining whether valid selection information exists;
displaying a targeted advertisement if valid selection information exists; and
displaying a non-targeted advertisement if valid selection information is not found.

64. A method for locating content, comprising:
retrieving a set of two or more attributes from at least one cookie;
combining said attributes;
forming a URL, said URL includes said combined attributes; and
communicating said URL to a server in order to access content.

65. A method according to claim 64, further comprising the steps of:
receiving said content in response to said step of communicating; and
reporting said content.

66. A method according to claim 64, further comprising the steps of:
finding said content at said server, said URL includes an explicit identification of a location within a file system to find said content, said step of finding uses said explicit identification;
transmitting said content from said server to a client, said steps of combining and forming are performed by said client; and
displaying said content on said client.

67. A method according to claim 64, wherein:
said attributes comprise category information, an index for said category information and one or more properties.

68. A method according to claim 64, wherein:
said attributes include a first attribute and a second attribute;
said URL includes an identification of a host, said first attribute and said second attribute; and
said URL includes an explicit identification of a location within a file system to find said content.

69. A method according to claim 68, wherein:
said first attribute corresponds to a first bit pattern; and
said second attribute corresponds to a second bit pattern.

70. A method according to claim 64, wherein:
said attributes include a first attribute and a second attribute; and
said first attribute and said second attribute are stored in one or more cookies.

71. A method according to claim 64, wherein:
said steps of combining and forming are performed by a client remote from said server; and
said one or more cookies reside on said client device.

72. A method according to claim 64, wherein:
said steps of combining and forming are performed by a client remote from said server; and
said one or more cookies reside on said server.

73. An apparatus, comprising:
one or more processors;
a communication interface in communication with said one or more processors and a network; and
one or more storage devices in communication with said one or more processors, said one or more storage devices store content, said one or more processors programmed to preform a method comprising the steps of:
retrieving a set of two or more attributes from at least one cookie,
combining said attributes,
forming a URL, said URL includes said combined attributes, and
communicating said URL to a server in order to access targeted content.

74. An apparatus according to claim 73, wherein said method further comprises the steps of:
receiving said targeted content in response to said step of communicating; and
reporting said targeted content.

75. An apparatus according to claim 73, wherein:
said attributes include a first attribute and a second attribute;
said URL includes an identification of a host, said first attribute and said second attribute; and
said URL includes an explicit identification of a location within a file system to find said content.

76. An apparatus according to claim 73, wherein:
said attributes include a first attribute and a second attribute; and
said first attribute and said second attribute are stored in separate cookies.

77. A method for providing content, comprising the steps of:
determining whether one or more cookies store valid attribute data; and
providing targeted content if said step of determining concludes that one or more cookies store valid attribute data.

78. A method according to claim 77, further comprising the step of:
providing alternate content if said step of determining does not conclude that one or more cookies store valid attribute data.

79. A method according to claim 78, wherein said step of providing targeted content includes the steps of:
adding said valid attribute data to a URL, said valid attribute data includes data from two or more cookies;
communicating said URL to a server;
receiving said targeted content from said server; and
displaying said targeted content.

80. A method according to claim 78, wherein:
said targeted content is a first advertisement pertaining to a first category;
said valid attribute data corresponds to said first category; and
said alternate content is a second advertisement that is not sorted by a category pertaining to said valid attribute data.

81. A method according to claim 77, wherein:
said valid attribute data is represented by one or more bit patterns.

82. A method according to claim 77, wherein:
said valid attribute data includes a first attribute, a second attribute and a third attribute;
said first attribute is stored in a first cookies;
said second attribute is stored in a second cookie; and
said third attribute is stored in a third cookie.

83. An apparatus, comprising:
one or more processors;
a communication interface in communication with said one or more processors and a network; and
one or more storage devices in communication with said one or more processors, said one or more storage devices store content, said one or more processors programmed to preform a method comprising the steps of:
determining whether one or more cookies store valid attribute data, and
providing targeted content if said step of determining concludes that one or more cookies store valid attribute data.

84. An apparatus according to claim 83, wherein said method further comprises the step of:
providing alternate content if said step of determining does not conclude that one or more cookies store valid attribute data.

85. An apparatus according to claim 83, wherein said step of providing targeted content includes the steps of:
adding said valid attribute data to a URL, said valid attribute data includes data from two or more cookies;
communicating said URL to a server;
receiving said targeted content from said server; and
displaying said targeted content.

86. An apparatus according to claim 85, wherein:
said targeted content is a first advertisement pertaining to a first category;
said valid attribute data corresponds to said first category; and
said alternate content is a second advertisement that is not sorted by a category pertaining to said valid attribute data.
